(19) United States
(12) Patent Application Publication
(10) Pub. No.: US 2007/0080519 A1
(43) Pub. Date: Apr. 12, 2007

(54) ADULT STROLLER

(76) Inventor: Janet L. Murdock, Canyon Country, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/538,328

(22) Filed: Oct. 3, 2006

Related U.S. Application Data
(60) Provisional application No. 60/724,190, filed on Oct. 6, 2005.

(51) Int. Cl. B62B 9/00

(52) U.S. Cl. 280/650; 280/647

(57) ABSTRACT

An adult stroller includes a movable frame adapted for use by a person to assist in ambulatory movement, and a canopy that is positioned substantially above and carried by the movable frame. A flexible shield extends downwardly from the front portion of the canopy to at least partially cover a front portion of the movable frame. Such coverage effectively protects a passenger from the environment or potential inclement weather.

### FIELD OF THE INVENTION

The present disclosure relates to a stroller. More particularly, the invention relates to a lightweight adult stroller to aid in the ambulatory movement of individuals having limited mobility, vitality, balancing, or neurological issues.

### BACKGROUND OF THE INVENTION

The current selection of flexible mobility devices for adolescents and adults having limited mobility, vitality, balance issues, or neurological difficulties, is limited. An overwhelming number of Americans, over 54 million as of the last Census report, suffer from some form of limited mobility. There are over 15 million who, alone, use walking canes. These numbers are sure to escalate as a growing percentage of the population reaches retirement age. By 2030, approximately twenty percent of the entire population will be 65 years old or older. Additionally, nearly one in a dozen adolescents has some form of physical or mental disability that precludes easy, pain free ambulatory transportation. Thus, there is already a large need to have access to easily transportable devices for aid in mobility of every aspect of life. While the selection of strollers for babies and infants may be abundant, the market for adult strollers has yet to develop. Targeting individuals in the above market is critical to adequate health care, especially considering the target consumer is increasing in percentage population.

Individual consumers in the targeted adult stroller market might specifically include persons afflicted with restricted ambulatory movement and their corresponding caregivers. On a broader scale, corporations comprising the $1.1 trillion United States medical industry also fall into the targeted market. Hospitals, health care facilities, and nursing homes are all potential consumers as these institutions strive to provide maximum comfort and flexibility for patients of all ages and sizes. These institutions have an abundant access to wheel chairs and fully motorized scooters. But, wheel chairs and fully motorized scooters are often heavy, obstructive, and require special facilities and retrofitted vehicles to transport equipment. The adult stroller is specially designed to eliminate the downfalls of these devices by being lightweight, versatile, and collapsible for easy storage and transportation. Flexibility and versatility allows stroller passengers to go more places and thus have fuller life experiences while riding in comfort.

Ambulatory injuries impair mobility and hence preclude enjoyment of many of life's activities. Such injuries might include spinal cord damage, stroke, advanced osteoporosis, and hip or joint replacement. While individuals may not be fully dependent on a wheelchair, getting from one place to another can be time-consuming, difficult, and frustrating without the aid of a mobility device. This is often the case in instances where an individual is required to walk or stand in one place for an extended period of time. Limited movement not only frustrates the person with the disability, but can often instill frustration with companions, caregivers, or other individuals having an intimate relation with the disabled person. Other types of chronic illnesses such as heart conditions, cancer, and other degenerative diseases may also make physical transportation difficult. Balance and coordination issues are also brought on by such conditions as head trauma, Parkinson's disease, Alzheimer's disease, Meniere's disease, dementia, or even middle ear disturbances. Individuals afflicted with such ambulatory restrictions will find relief in an adult stroller in their everyday lives as a mobility aid.

Thus, there exists a significant need for an adult stroller capable of transporting an adolescent or adult having limited mobility, balance issues, or neurological difficulties. Such an improved stroller should include a lightweight and/or foldable construction for easy movement, a means for protecting a passenger from the environment, capacity for transporting medical devices or other goods, and a mechanism to control the stroller when left unattended with a passenger inside. The present invention fulfills these needs and provides further related advantages.

### SUMMARY OF THE INVENTION

Herein disclosed is a specially designed assistive mobility device configured for use by adolescents and adults. This adult stroller includes four wheels and a frame manufactured from a light weight material such as heavy gauge nylon or vinyl, aluminum, or other suitable material. The durable, yet flexible design allows the adult stroller to be used in parks, stores, amusement parks, and around town. The adult stroller provides adolescents and adults a means for a safer, easier, and comfortable mode of transportation. Adult stroller passengers will be able to once again go shopping, see movies, and enjoy parks, even in inclement weather. The stroller is easily storable, has a variety of safety features, is perfectly adjustable, and is an ideal replacement for wheel chairs and fully motorized scooters.

The adult stroller frame is versatile and foldable for easy storage. In general, the frame is supported by a series of four wheels. Two wheels in the front are fixed while the two rear wheels swivel. Although, a variety of wheel combinations are possible. Stroller movement is controlled by a person through use of a rear handle that curves back similar to a shopping cart. Also integrated into the frame design is a brake bar located parallel to the rear handle. The brake bar runs adjacent down the side of the frame and connects to a brake unit. When resting, the brake unit engages and locks at least one of the stroller wheels. This safety feature prevents inadvertent movement or accidental rolling of an unattended stroller. A person, such as a caregiver, attempting to move the stroller need only pull the brake bar to disengage the brake unit. After stopping and releasing the brake bar, the brake unit reengages at least one of the wheels to again prevent movement.

The adult stroller also includes a front and rear weather shield. The front shield is connected to a canopy mounted to a top portion of the adult stroller frame. The combination of the canopy and the front shield protects an adult stroller passenger from the environment—including the sun and inclement weather. A section of the front shield is manufactured from a clear plastic material to allow a passenger to see out. The bottom portion of the front shield may be made from any weather resistant material, such as nylon. While the front shield may be designed in many different sizes, the front shield should ideally be long enough to completely cover a passenger's legs and feet. The front shield may substantially cover and connect to a front portion of the frame to further protect the passenger from the outside environment. For storage, the front shield may be folded under the canopy or folded above the canopy. Additionally, a rear shield is stored underneath the canopy in a pocket, or rolled up and secured with pull tabs, or stored by another suitable means. The rear shield is used to substantially cover the rear side of the adult stroller frame. When the front and rear shields are both deployed, a passenger is completely enclosed within the adult stroller and thus protected from the environment.

In addition to protection from the environment, the adult stroller also includes a variety of comfort options. A seat support incorporates several padded seat designs, adjustable head rests, and neck support options. For persons with specific or particularly painful back problems, an optional detachable and adjustable lumbar support device may be mounted to the seatback. Persons dependent upon respirators or other respiratory aid devices have the option of storing an oxygen tank or other medical equipment in specially designed seatback pockets. The seatback is adjustable and configured to recline into a variety of positions to maximize comfort. The combination of a lower seatbelt and an upper shoulder belt help retain passengers. The lower seatbelt is threaded through a “V” shaped metal fitting that allows the lower seatbelt or the shoulder seatbelt to be used together or separately. The seatbelts are secured by Velcro or other suitable material having durable construction. Armrests reside on each side of the frame and may incorporate a basket-type cup holder for storing beverages. An optional tray attaches over the armrests. Furthermore, the foot rest folds up to enable a passenger to stand in close proximity to the seat when sitting down and standing up. A flexible storage compartment resides in back of the footrest and is integrated into the base of the adult stroller frame. This storage compartment compacts when the adult stroller frame is collapsed. An optional wire or mesh basket can be secured to the handle for shopping or additional storage.

The above and other objects and the nature and advantages of the present disclosure will be more apparent from the following detailed description of certain specific embodiments thereof, taken in conjunction with the drawings, wherein:

### BRIEF DESCRIPTION OF THE DRAWINGS

The accompanying drawings illustrate the invention. In such drawings:

FIG. 1 is a perspective view of an adult stroller including an exploded view of a canopy and a protective shield attachment;

FIG. 2 is a perspective view of an adult stroller including a front shield rolled above an attached canopy;

FIG. 3 is a perspective view of an adult stroller including a front shield rolled under an attached canopy;

FIG. 4 is a perspective view illustrating attachment of a rear shield to the rear side of an adult stroller;

FIG. 5 is a perspective view illustrating a rear shield attached to the rear side of an adult stroller;

FIG. 6 is a perspective view illustrating attachment of a canopy, front shield, and a rear shield encapsulating the frame of an adult stroller;

FIG. 7 is a perspective view of an adult stroller including a brake unit;

FIG. 8 is a perspective view of an adult stroller including armrests and a basket-type holder;

FIG. 9 is a perspective view of an adult stroller including a seatbelt;

FIG. 10 is a perspective view of an adult stroller including an alternative set of supports;

FIG. 11 is a perspective view of an adult stroller including a padded seat cushion;

FIG. 12 is a side view of an adult stroller having a brake unit;

FIG. 13 is a side view of an adult stroller illustrating multiple seatback configurations;

FIG. 14 is a side view of an adult stroller illustrating multiple armrest positions; and

FIG. 15 is a side view of an adult stroller as collapsed.

### DETAILED DESCRIPTION OF THE PREFERRED EMBODIMENT

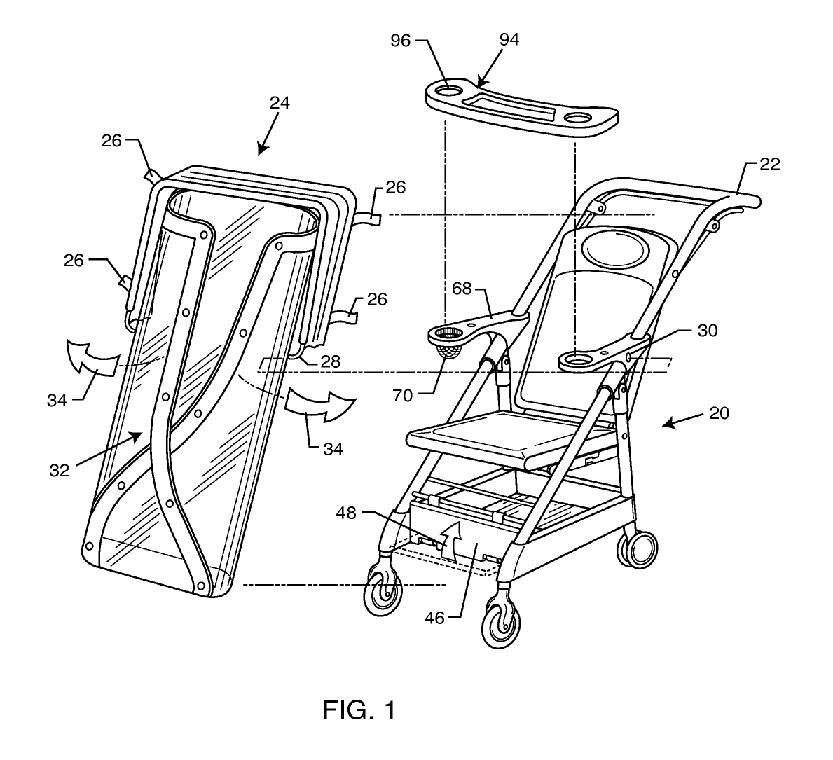

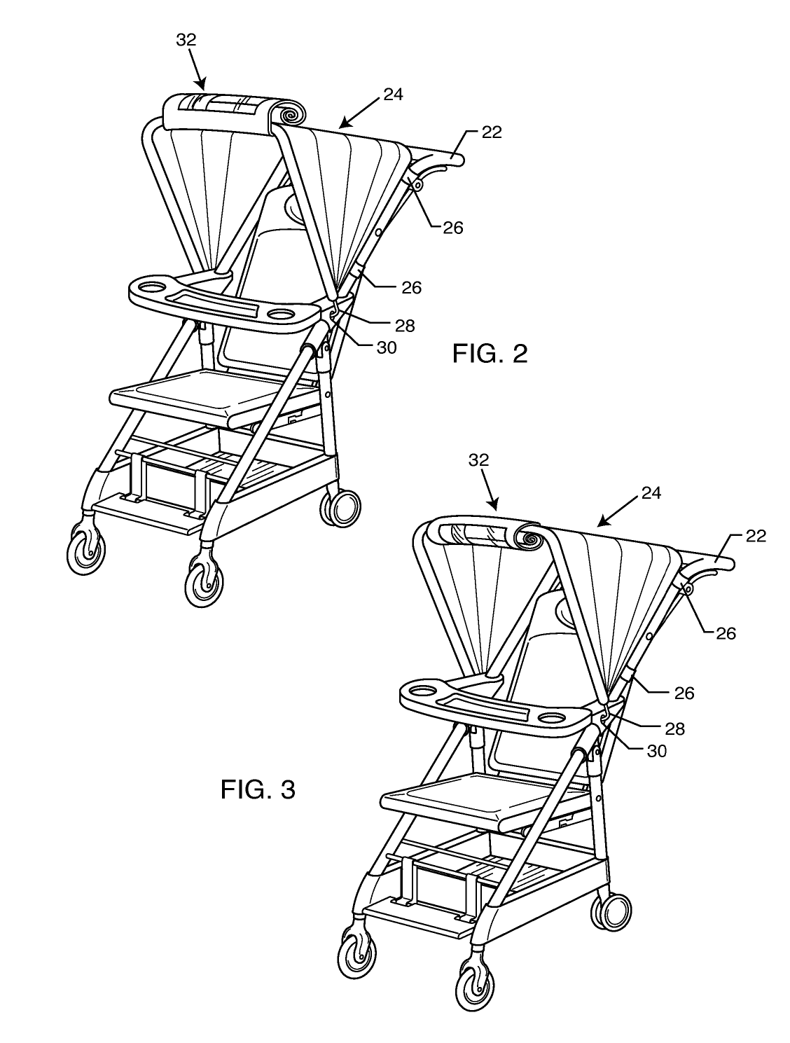

As shown in the exemplary drawings for purposes of illustration, the present disclosure for an adult stroller is referred to generally by the reference numeral 20. Turning now to the representative figures in the specification, FIG. 1 illustrates an adult stroller 20 having a frame 22. The frame 22 is generally constructed from a lightweight and durable material such as heavy gauge nylon, heavy gauge vinyl, aluminum, or other suitable materials meeting such criterion. The frame 22 is configured to receive a retractable canopy 24 by connecting a set of canopy bar straps 26 around the frame 22. FIGS. 2 and 3 illustrate the canopy 24 fully extended and attached to the frame 22 with the canopy bar straps 26. A person of ordinary skill in the art will recognize that the canopy bar straps 26 could include any type of attachment mechanism including screws, nails, a hook and loop configuration, snaps, buttons, Velcro, or other suitable attachment mechanism capable of retaining the canopy 24 to the frame 22. As shown in FIGS. 2-4, the canopy 24 is supported by a rigid canopy support bar 28 that is connected to the frame 22 via a canopy attachment aperture 30. The canopy 24 is designed to shield a passenger from the sun or other inclement weather such as rain, snow, sleet, or wind. The canopy 24 is retractable and thus must be made out of a flexible, weather resistant, and durable material. Suitable materials might include flexible plastics, nylon, or Gore-Tex®.

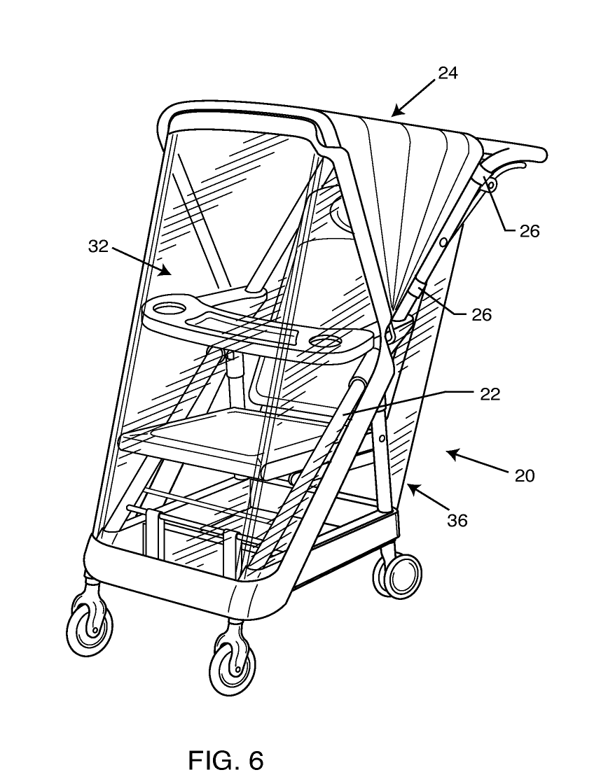

Referencing FIG. 1, a front shield 32 is attached to the canopy 24. The front shield 32 is generally positioned above the frame 22 and the canopy 24 to provide shelter for a passenger. Ideally, the front shield 32 is made from a clear plastic-type material such that a passenger can see out from the bottom portion of the frame 22. The material of the front shield 32 must also be able to withstand the environment (wind, rain, snow, etc.), while enabling the passenger to breathe comfortably while riding in the stroller 20. Suitable materials for the front shield 32 might include nylon or a micro-fiber weave as they are substantially weather resistant. A person of ordinary skill in the art will recognize that any weather resistant, yet flexible material known in the art may be used to form the front shield 32. The front shield 32 may attach to the base of the frame 22 by means of snaps, buttons, Velcro, adhesive, or any other suitable connection means (not shown). The front shield 32 is also collapsible and may be stored above the canopy 24 (FIG. 2) or below the canopy 24 (FIG. 3). Upon deployment, the front shield 32 is unraveled longitudinally and extended outwardly along a set of arrows 34 in FIG. 1. FIG. 6 illustrates the stroller 20 with the canopy 24 fully extended and the front shield 32 fully deployed to substantially encapsulate the front portion of the frame 22. As shown in FIG. 6, the front shield 32 is long enough to completely cover the rider's legs and feet. A person of ordinary skill in the art will recognize that there are many different configurations for the canopy 24 and the front shield 32. For example, the canopy 24 may have a significantly greater width or length than the frame 22. The front shield 32 may only partially cover the height of the frame 22 depending on the application. It should also be recognized that various combinations of the canopy 24 and the front shield 32 are possible because the combination is removable via the canopy bar straps 26 (FIGS. 1-6).

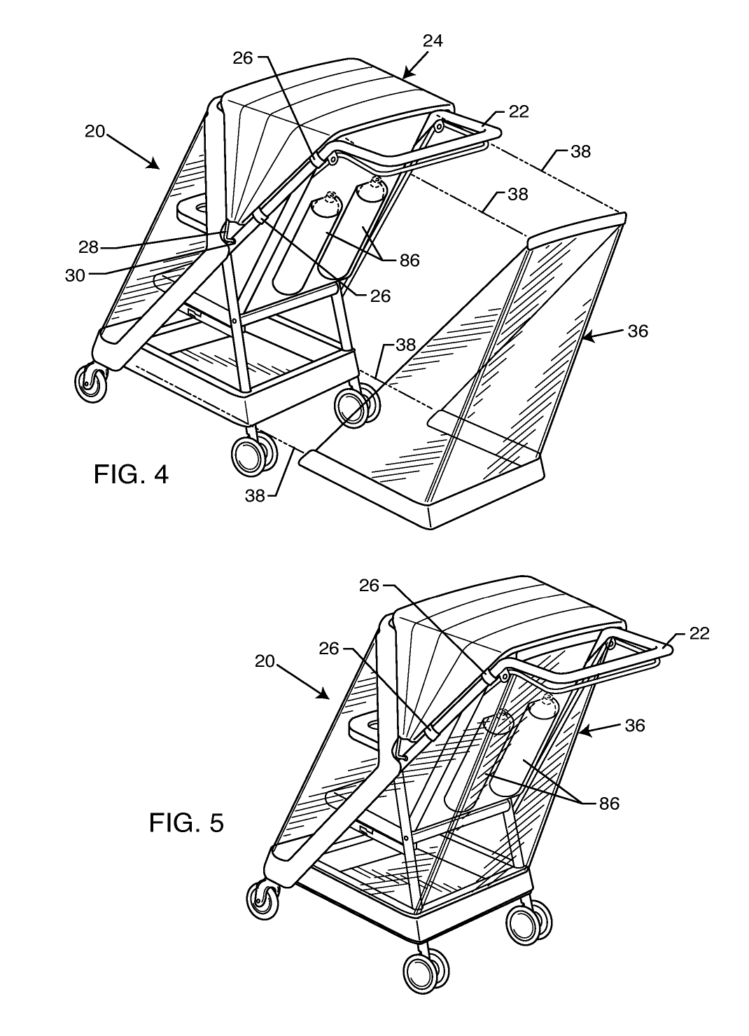

Additionally, the frame 22 is configured to receive a removable rear shield 36 as illustrated in FIGS. 4-6. FIG. 4 specifically discloses an exploded view of the frame 22 set to receive the rear shield 36 along a set of phantom lines 38. The rear shield 36 is foldable and can be stored underneath the frame 22, or a pocket or other holder mounted to the frame 22. The rear shield 36 is connected to the frame 22 via attachments such as screws, nails, a hook and loop configuration, snaps, buttons, Velcro, or other suitable mechanisms known in the art. In FIG. 6, the frame 22 of the stroller 20 is completely enclosed by the canopy 24, the front shield 32, and the rear shield 36. The entire enclosure protects passengers from the outside weather, including sun, snow, wind, or rain. Like the front shield 32, the dimensions of the rear shield 36 could also vary in width, height, and length depending on the desired application. For example, a passenger might want a canopy with a smaller shield for protection only against the sun on a sunny day. Alternatively, a passenger might want to be encapsulated by the canopy 24, the front shield 32, and the rear shield 36 combination for protection against cold wind, rain, or snow. Since the rear shield 36 is detachable, it is also envisioned that a variety of different styles and configurations could be used depending on the desired application. Different rear shields are configured to be carried by the canopy 24 or another suitable storage device associated with the stroller 20.

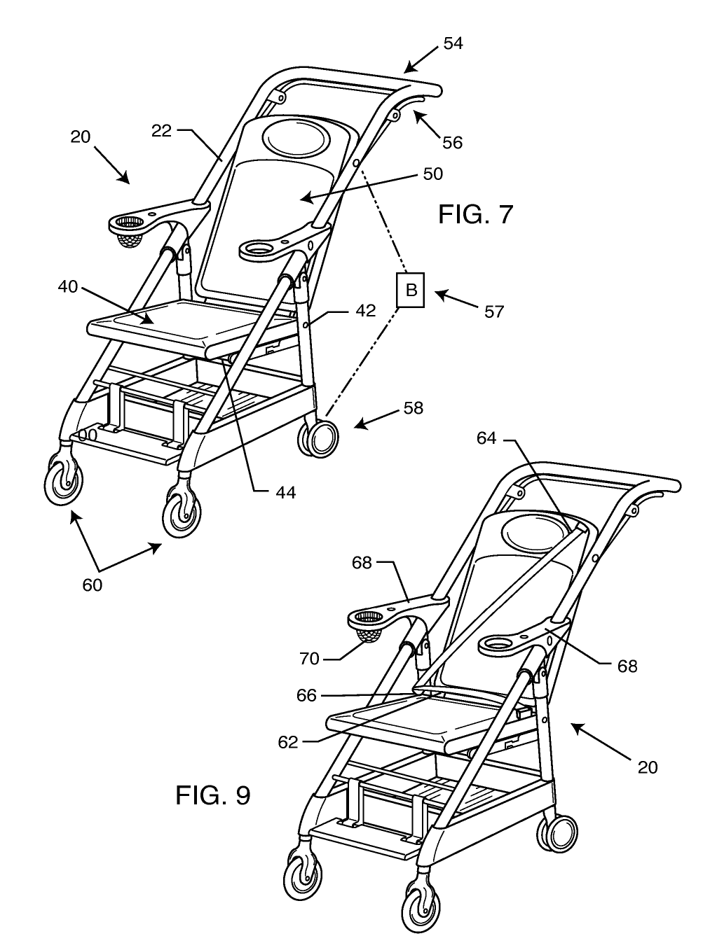

As further illustrated in FIG. 7, the stroller 20 includes a seat 40 pivotally connected to the frame 22 at a pivot point 42. The seat 40 should be manufactured from a substantially rigid material that can withstand the weight of an adolescent or adult. The seat 40 is further supported by a seat bar 44. The seat bar 44 is rigidly connected to the frame 22 as illustrated and able to withstand the weight of any passenger such that the seat 40 is retained in a substantially horizontal position when deployed. The combination of the seat bar 44 and the seat 40 are designed to carry a variety of individuals including adolescents and adults ranging up to the ninetieth percentile in size and weight. When attempting to sit down into the seat 40 or standup from the seat 40, the stroller 20 further includes a footrest 46 (FIG. 1) which folds along a directional arrow 48. When the footrest 46 is folded, a passenger can stand in close proximity to the seat 40. Turning back to FIG. 7, a seatback 50 is also provided and mounted to the frame 22 via the pivot point 42. FIG. 13 illustrates a series of seatback tabs 52 that enable the seatback 50 to be retained by the frame 22 in a variety of reclining positions. One reclined position is noted in phantom. Passengers may adjust comfort settings by altering the location of the seatback tabs 52. Persons with back pain may choose a position substantially reclining. Persons having spinal cord problems or that are affected by scoliosis, may choose a substantially upright position.

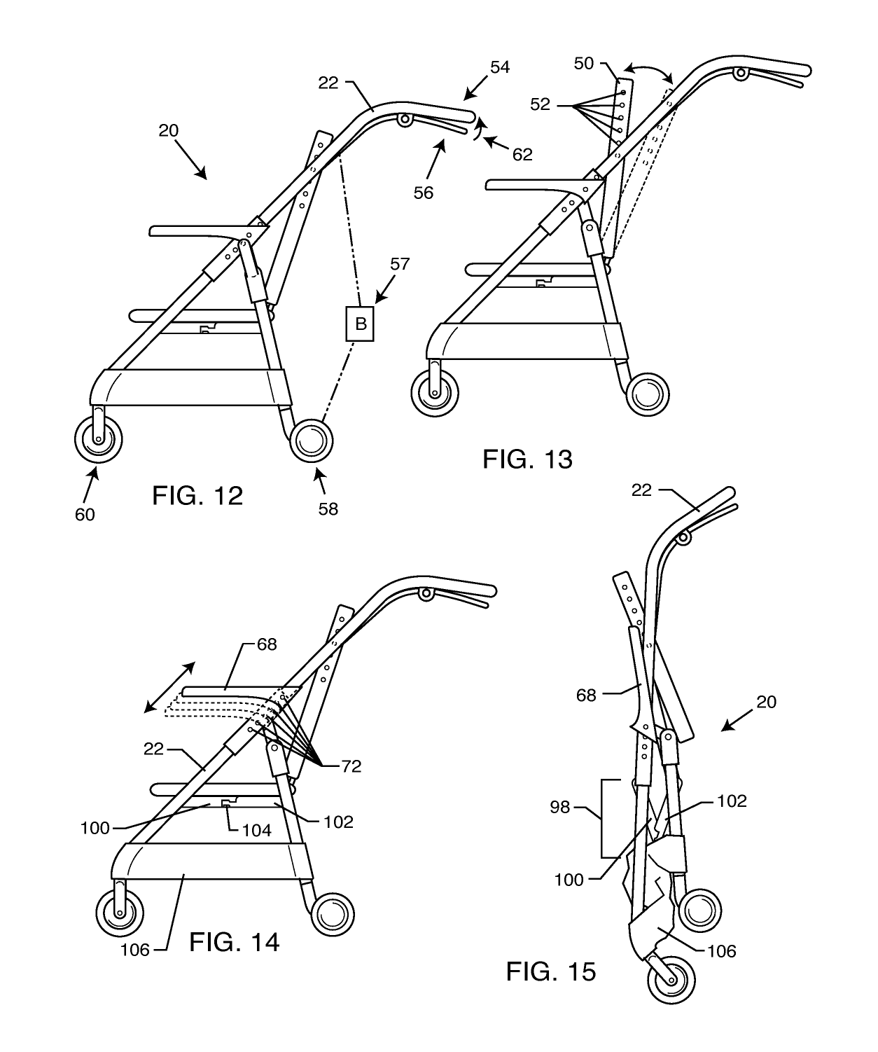

Safety also accompanies comfort in the adult stroller. One safety feature of the adult stroller resides in the control and brake system as generally depicted in FIGS. 7 and 12. The stroller 20 is controlled and operated by a caregiver or other individual through use of a handle 54. The handle 54 is adjustable such that it can accommodate individuals of different sizes. The adjustability of the handle 54 may include a telescoping feature such that the handle 54 may be lowered for easier storage or raised to accommodate taller individuals. Thus, individuals may customize the location of the handle 54 to achieve better comfort and control over the stroller 20.

A brake bar 56 is adjacent to the handle 54 and runs parallel down the backside of the frame 22. As generally illustrated in FIGS. 7 and 12, the brake bar 56 is coupled to a braking unit 57, which in turn is coupled to one of a pair of rear swivel wheels 58. It is conceived that the braking unit 57 could also engage any one of a pair of front stationary wheels 60. The combination of the rear swivel wheels 58 with the front stationary wheels 60, provide the proper maneuverability and directional drive stability necessary for an individual operating the stroller 20 via the handle 54 to easily traverse a variety of terrains. It should be recognized that a variety of different mechanisms could be used to enable mobility of the stroller 20. Such devices might include a variety of different wheels, rollers, castors, or skis. Additionally, a person of ordinary skill in the art will readily recognize that any combination of such devices could be used. For example, the stroller 20 could consist of a set of four stationary wheels, or a set of four swivel wheels, or a pair of stationary wheels mounted with a pair of skis.

As shown in FIG. 12, the connection between the brake bar 56 and the braking unit 57 enables a person operating the stroller 20 via the handle 54 to selectively engage or disengage the braking unit 57. When the brake bar 56 is in a resting position, the brake unit 57 automatically engages one of a pair of the rear swivel wheels 58, thereby preventing inadvertent movement of the stroller 20. When the brake bar 56 is pulled toward the handle 54 along the arrow 62, the braking unit 57 disengages one of the rear swivel wheels 58 to enable movement of the stroller 20. The person controlling the stroller 20 via the handle 54 and the brake bar 56 must retain the brake bar 56 against the handle 54 to continue to enable mobility of the stroller 20. Once the brake bar 56 is released back to an initial resting position, the brake unit 57 reengages one of the rear swivel wheels 58 and the stroller 20 is thereafter prevented from moving. The brake unit 57 is not limited to engagement of only one of the rear swivel wheels 58. The brake unit 57 could engage one or both of the rear swivel wheels 58, one or both of the front stationary wheels 60, or any combination of wheels or other mobility enhancing devices thereof.

Turning now to FIG. 9, the stroller 20 further incorporates a dual safety belt combination including a lap seatbelt 62 and a shoulder seatbelt 64. When the lap seatbelt 62 is threaded through a “V” shaped metal fitting 66 either the lap seatbelt 62 or the shoulder seatbelt 64 could be utilized. Alternatively, both the lap seatbelt 62 and the shoulder seatbelt 64 could be used simultaneously. The lap seatbelt 62 and the shoulder seatbelt 64 may be secured around a passenger by a clip, a traditional seatbelt locking device found in cars or airplanes, an adhesive, Velcro, buttons, snaps, or other suitable retaining mechanism known in the art. The lap seatbelt 62 and the shoulder seatbelt 64 are particularly ideal for retaining passengers prone to involuntary muscular movements and who may be susceptible to falling out of the stroller 20. Passengers may use a set of armrests 68 for stability when sitting down or standing up or for comfort when riding in the stroller 20. The armrests 68 generally have a wide formation for maximum comfort and utility. A basket type cup holder 70 may be incorporated into one or both of the armrests 68. The cup holder 70 is configured to retain beverage cups or other containers storing food, medication, or personal belongings. Adjustability of the armrests 68 is illustrated in FIG. 14. The armrests 68 may be raised or lowered along the directional arrow depending on the size and shape of the passenger. A set of spaced armrest connection points 72 located along the side of the frame 22 provide connection points to adjust the armrests 68. The armrests 68 may be adjusted and connected to the frame 22 at the armrest connection points 72 by any means well known in the art. Such connection mechanisms might include a sliding engagement mechanism, snaps, clips, or Velcro.

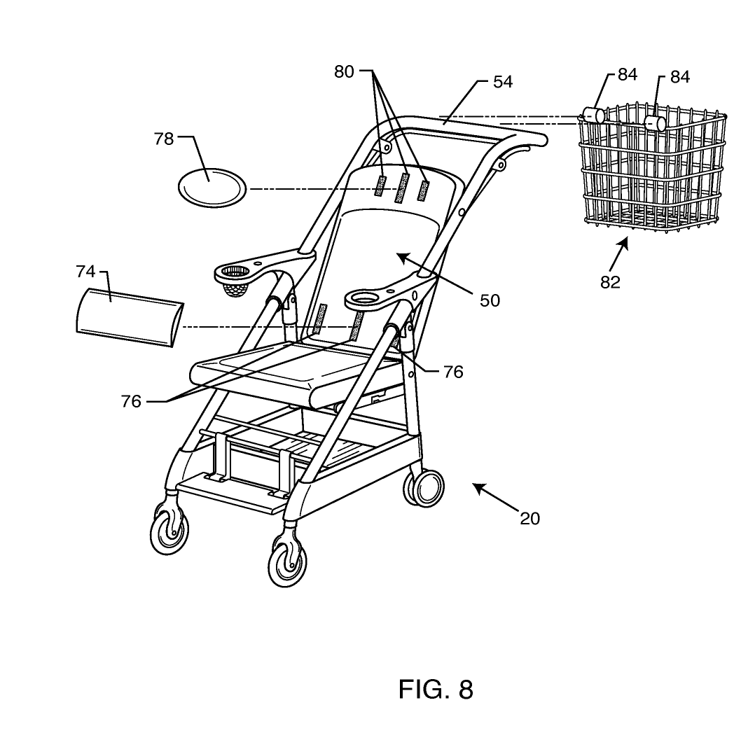

Next, FIG. 8 discloses the stroller 20 incorporating a set of customizable modifications. First, the stroller 20 may include an adjustable lumbar support 74. The lumbar support 74 may be attached and positioned anywhere along a variety of lumbar connection strips 76 located on the seatback 50. Securing the lumbar support 74 to the lumbar connection strips 76 may be accomplished by a variety of mechanisms such as snaps, adhesive, Velcro, or any combination of securement methods known in the art. Users have the option of incorporating different sized lumbar to correspond with the passenger's size and shape. It is also conceived that more than one lumbar support 74 may be used. The adjustability of the lumbar support 74 along the lumbar connection strips 76 provides for maximum comfort and enjoyment while riding in the stroller 20.

FIG. 8 further illustrates use of an adjustable neck support 78 with the stroller 20. A series of neck support connection strips 80 provide a means for attaching and adjusting the neck support 78. Like the lumbar support 74, any combination of connection mechanisms, including snaps, adhesives, Velcro, or other methods known in the art, may be used to adjust and retain the neck support 78 to the seatback 50 for maximize comfort. The neck support 78 is also offered in a variety of shapes and sizes to provide greater versatility for a wider range of potential passengers. It is also envisioned that the neck support 78 could be used as a head support for younger or shorter passengers. FIG. 8 also illustrates the use of a wire or mesh basket 82 capable of being mounted to the handle 54 via a set of basket mounting clips 84. The basket 82 may be used to carry a variety of personal items, goods, or medical supplies. Lastly, FIGS. 4 and 5 also disclose a pair of seatback pockets 86 ideal for carrying an oxygen tank, an ambulatory aid, or other suitable goods or personal items.

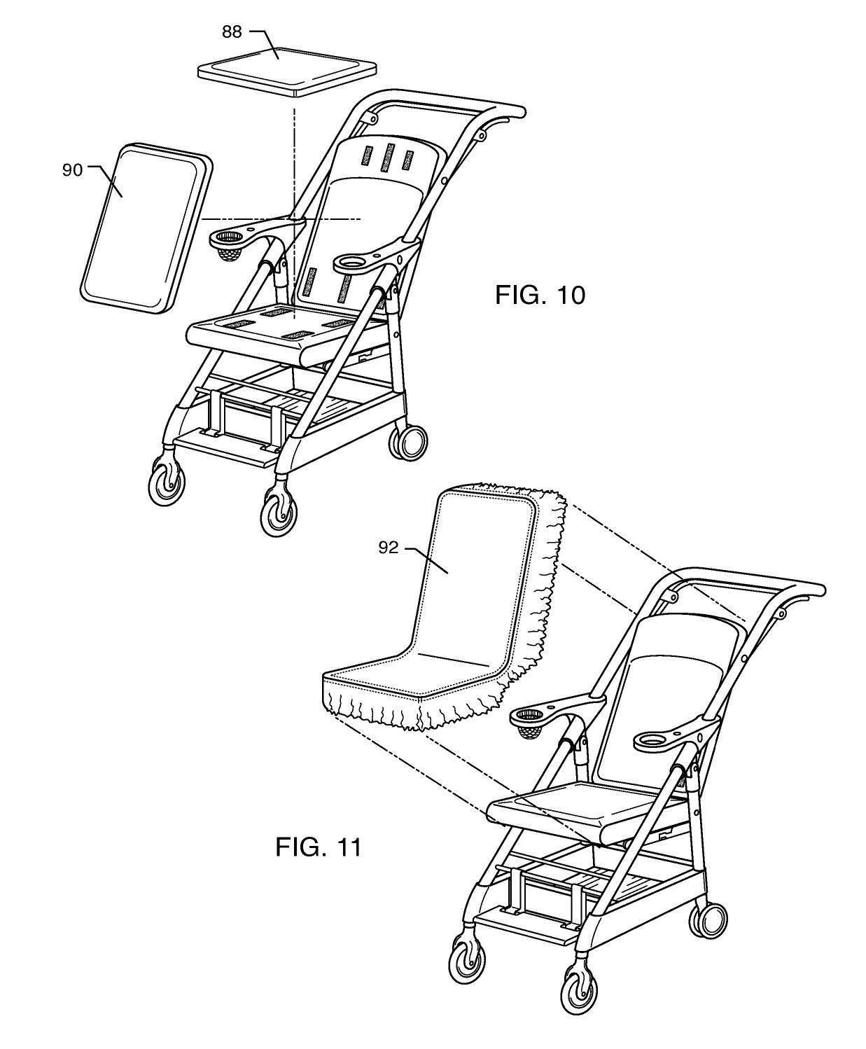

FIG. 10 further discloses the use of a seat pad 88 and a seatback pad 90. A combination of designs may comprise the seat pad 88 or the seatback pad 90. For example, individuals that have severe back or pain from sitting for long periods of time may opt for a thick pad 92 as depicted in FIG. 11. It is conceivable that a variety of combinations may be used for the seat pad 88 and the seatback pad 90 including integrated back supports, cushions, formable pads, or other items known in the art. Turning back now to FIG. 1, a tray 94 is illustrated in exploded view from the armrests 68. The tray 94 is capable of utilizing the cup holder 70 by placing a beverage through a pair of tray apertures 96. The tray 94 has a variety of uses that might include storing or carrying items desired to be transported, retaining food or other beverages, or further providing a place to rest arms or other parts of the body during travel.

Lastly, FIG. 15 discloses the frame 22 of the stroller 20 in a collapsed position. A horizontal support bar 98 consists of two members, a front side member 100 and a rear side member 102. The front side member 100 and the rear side member 102 are pivotally connected to the frame 22. The front side member 100 and the rear side member 102 are also pivotally connected to one another along a support bar pivot point 104 (FIGS. 14 and 15). When the stroller 20 is in operational form, as illustrated in FIG. 14, the support bar pivot point 104 is in a locked position. The locked position may include any means of preventing the support bar pivot point 104 from moving or inadvertently collapsing. When a user desires to collapse the stroller 20, the user applies downward pressure at the support bar pivot point 104 to break the support bar pivot point 104 from its locked position. The linkage between the front side member 100 and the rear side member 102 allows the stroller 20 to collapse along the width of a flexible container 106 (FIGS. 14 and 15). For easier storage the armrests 68 fold vertically to become substantially parallel with the rest of the frame 22 of the stroller 20 as illustrated in FIG. 15.

A variety of modifications and improvements to the adult stroller of the present disclosure will be apparent to those skilled in the art. Accordingly, those skilled in the art will appreciate that such changes may be made without departing from the underlying principles of the present disclosure. The above-described disclosure is not intended to limit the scope of the invention. Accordingly, the scope of the present invention is determined only by the following claims.

What is claimed is:

1. A stroller for assisting in ambulatory movement of a person, comprising:
a movable frame including a support for the person;
a canopy carried by the frame and positioned above the support; and
a flexible shield extending downwardly from the canopy to provide protection for the person.

2. The stroller of claim 1, wherein the canopy is attachable to an upper portion of the frame and is selectively deployable between extended and retracted positions.

3. The stroller of claim 1, wherein the shield is selectively deployable from a retracted position to an extended position, wherein when in the extended position, the shield extends downwardly to substantially cover a front periphery of the frame.

4. The stroller of claim 3, wherein the shield attaches to the front periphery of the frame to further insulate the support and the person thereon.

5. The stroller of claim 3, further including a rear shield substantially covering a rear side of the frame.

6. The stroller of claim 5, wherein the canopy, the shield, and the rear shield cooperate to substantially encapsulate the support and the person thereon.

7. The stroller of claim 1, wherein the shield comprises a breathable material.

8. The stroller of claim 1, wherein the shield comprises a transparent material.

9. The stroller of claim 1, wherein the frame further comprises a brake for selectively preventing movement of the frame.

10. The stroller of claim 9, wherein the brake comprises at least one brake unit selectively engagable to at least one of a series of wheels, whereby when the brake is in an initial position it engages a portion of the wheel effectively preventing movement of the frame, and when the brake is displaced to a subsequent position it effectively disengages from the wheel, thereafter enabling movement of the frame.

11. The stroller of claim 9, wherein the frame includes a handle that enables a caregiver to control movement of the frame and provides a control lever for the brake.

12. The stroller of claim 11, further including a basket attachable to the handle.

13. The stroller of claim 1, wherein the support comprises a seat and a seatback.

14. The stroller of claim 13, wherein the seat includes at least one cushion, and the seatback has a lumbar support.

15. The stroller of claim 13, wherein the seatback includes an oxygen tank receiving pocket.

16. The stroller of claim 1, wherein the frame includes a seatbelt.

17. The stroller of claim 16, wherein the seatbelt comprises a lap seatbelt or a shoulder seatbelt.

18. The stroller of claim 1, wherein the frame is collapsible.

19. A stroller for assisting in ambulatory movement of a person, comprising:
a movable frame including a support for the person;
a canopy carried by the frame and positioned above the support, wherein the canopy is attachable to an upper portion of the frame and is selectively deployable between extended and retracted positions;
a flexible shield extending downwardly from the canopy to provide protection for the person, wherein the shield is selectively deployable from a retracted position to an extended position such that when in the extended position, the shield extends downwardly to substantially cover a front periphery of the frame; and
a rear shield substantially covering a rear side of the frame, wherein the canopy, the shield, and the rear shield cooperate to substantially encapsulate the support and the person thereon.

20. The stroller of claim 19, wherein the shield comprises a breathable material or a transparent material.

21. The stroller of claim 19, wherein the frame further comprises a brake for selectively preventing movement of the frame and a handle that enables a caregiver to control movement of the frame and provides a control lever for the brake.

22. The stroller of claim 21, wherein the frame includes a seatbelt.

23. The stroller of claim 21, further including a basket attachable to the handle.

24. The stroller of claim 19, wherein the support comprises a seat and a seatback, wherein the seatback includes an oxygen tank receiving pocket.

25. The stroller of claim 24, wherein the seat includes at least one cushion, and the seatback has a lumbar support.

26. The stroller of claim 19, wherein the frame includes a seatbelt comprising a lap seatbelt or a shoulder seatbelt.

27. A stroller for assisting in ambulatory movement of a person, comprising:
a movable frame including a support for the person;
a canopy carried by the frame and positioned above the support;
a flexible shield extending downwardly from the canopy to provide protection for the person, wherein the shield is selectively deployable from a retracted position to an extended position, wherein when in the extended position, the shield extends downwardly attaching to and substantially cover a front periphery of the frame to insulate the support and person thereon; and
a handle formed from the frame that enables a caregiver to control movement of the frame and provides a control lever for a brake, wherein the brake selectively prevents movement of the frame and comprises at least one brake unit selectively engagable to at least one of a series of wheels, whereby when the brake is in an initial position it engages a portion of the wheel effectively preventing movement of the frame, and when the brake is displaced to a subsequent position it effectively disengages from the wheel, thereafter enabling movement of the frame.

28. The stroller of claim 27, wherein the canopy is attachable to an upper portion of the frame and is selectively deployable between extended and retracted positions, and includes a rear shield substantially covering a rear side of the frame, wherein the canopy, the shield, and the rear shield cooperate to substantially encapsulate the support and the person thereon.

29. The stroller of claim 28, wherein the shield comprises a breathable material or a transparent material.

30. The stroller of claim 27, further including a basket attachable to the handle, wherein said support further comprises a seat and a seatback, the seat including at least one cushion, and wherein the seatback includes a lumbar support and an oxygen tank receiving pocket.

31. The stroller of claim 27, further including a seatbelt, wherein the seatbelt comprises a lap seatbelt or a shoulder seatbelt.

32. The stroller of claim 27, wherein the frame is collapsible.
